(19) United States
(12) Patent Application Publication
(10) Pub. No.: US 2005/0061324 A1
(43) Pub. Date: Mar. 24, 2005

(54) Medication delivery device & method

(76) Inventor: Mahfouz Tadros, Cresskill, NJ (US)

Correspondence Address: Kevin J. McNeely, Suite 440, 5335 Wisconsin Avenue, NW, Washington, DC, 20015, US

(21) Appl. No.: 10/945,080

(22) Filed: Sep. 21, 2004

Related U.S. Application Data
(60) Provisional application No. 60/504,436, filed on Sep. 22, 2003.

(51) Int. Cl. A62B 18/02

(52) U.S. Cl. 128/205.25; 128/206.21; 128/207.13; 128/206.24; 128/206.26; 128/206.27

(57) ABSTRACT

A nasal drug delivery system delivering aerosolized medication through the nose of a user includes a nasal mask with a concave wall having an upper portion widening to a base portion, a sealing member surrounding an edge of the wall such that the nasal mask defines a sealed chamber in fluid communication with the nasal passages of the user, a port providing fluid communication with the chamber, the port being positioned in the upper portion of the nasal mask, and an aerosolizer device connected to the port of the nasal mask thereby delivering an aerosolized medication to the chamber. The aerosolized medication delivered to the chamber enters the nasal passages during a normal inhalational breathing pattern of the user.

### CROSS REFERENCE TO RELATED APPLICATIONS

This application claims priority from U.S. Provisional Application No. 60/504,436 filed Sep. 22, 2003, which is incorporated herein by reference.

### FIELD OF THE INVENTION

This invention relates to medication delivery devices, and, more particularly, to a new and improved apparatus to deliver medication through the nasal passages.

### BACKGROUND OF THE INVENTION

The nose is divided by a septum into two nostrils that filter, moisten, and warm the air to protect the respiratory system. The flow of air in each nasal passage can be divided into upper, median, and lower airflow streams.

The sidewalls of the nostrils are irregular due to three baffles or turbinates referred to as the superior, middle, and inferior turbinates. The turbinates are bony shelves covered with soft tissue and mucosa that run through the length of the nose and cause a turbulent airflow in the nasal cavities. This turbulence causes air flowing through the nasal passage to have greater contact with mucous membranes and deeper penetration into the nasal cavities rather than that which would result from smooth or laminar airflow.

Recent advances in medication administration technology have shown the efficacy of using the nasal cavity as an alternative “needleless” drug administration route. Typical nasal cavity administered medications include antibiotics, steroids, antifungals and many more medications often used to treat a localized condition in the sinus area or nasal cavity where local application of a medication into the nasal cavity is preferable.

Nasal drug delivery has a number of advantages since it is an easy and convenient access point that eliminates the risk of a needle stick. Nasal administration also minimizes the systemic effects of oral and intravenous drug administration medications. For example, nasal drug delivery avoids the stomach and small intestine so acid and digestive enzymes do not destroy medication. Nasal delivery also avoids the portal circulation, so the medication is not subject to extensive destruction by the liver.

A number of devices are currently used to administer medication through the nasal passages. These include pressurized devices that are directly inserted into the nostrils to administer medication. These and similar devices produce a spray or aerosol that enters the nostrils in a laminar flow pattern.

The direct streaming of medication directly into the nostrils has been assumed to be an optimal delivery method. However, laminar flow causes the medication to skim the floor of the nasal cavity, resulting in laryngotracheal deposition of medication despite intranasal administration. In particular, this method delivers significant amounts of medication to the posterior nasopharynx or laryngotracheal region.

While some conventional oral nebulization masks exist, these masks are typically used for intensive care patients and pediatric patients who cannot effectively use a standard mouthpiece, and are not designed with the intention of maximizing turbulent, strictly nasal delivery of medication. These existing face masks cover both the nose and mouth and are intended primarily for intraoral administration of pulmonary medications, such as steroids and bronchodilators used for asthmatics. When using this type of device, some intranasal and intraoral cross-inhalation of medication occurs which is not desirable.

Thus, a need exists to develop a strictly nasal drug delivery device that preserves and/or accentuates a turbulent flow pattern to deposit medication within the nose.

### SUMMARY

This invention is designed for the convenient and reliable intranasal distribution of topical fluid medication to a patient. The importance of this design is to preserve and enhance the normal pattern of turbulent air flow for intranasal deposition of aerosolized medications. The emphasis is to discount the efficacy of any system that produces laminar flow such as air nozzles, intranasal prongs, nasal syringes or any form of pressurized flow directly into the nostrils.

The design is further intended to fit to standard nebulizer medication reservoir tubing to enable patients to have the flexibility of choosing their nebulizer system based on physician/patient preference or affordability, or to use their existing compressor systems pending compatibility with the prescribed medication. Jet stream compressors can be used with most medications for such purpose. Medication compatibility must be verified with the compressor component of the system only. The adaptor has no motorized component, and as such does not affect the stability of any medications delivered through it.

In one general aspect, a nasal drug delivery system delivering aerosolized medication through the nasal passages of a user includes a nasal mask with a concave wall having an upper portion widening to a base portion, a sealing member surrounding an edge of the wall, and a port providing fluid communication with the chamber. The wall defines a sealed chamber in fluid communication with the nasal passages of the user and the port is positioned in the upper portion of the nasal mask. An aerosolizer device is connected to the port of the nasal mask and is operable to deliver the aerosolized medication to the chamber. The aerosolized medication in the chamber is available to enter the nasal passages during a normal inhalational breathing pattern of the user. Implementations may include an aerosolizer device that is an air pressure source that aerosolizes the medication via a medication cup and delivering the aerosolized medication to the chamber or it may be a nebulizer.

In another general aspect, a method of intranasal medication delivery includes aerosolizing a medication, delivering the medication to a chamber configured to envelope a nose of a medication user, and causing a turbulent flow of the aerosolized medication to be made available to enter the nasal cavity of the medication user.

Implementation may include features described above or one or more of the following features. For example, the method may further include depositing the aerosolized medication along the lining of the nasal cavity or depositing the aerosolized medication to a superior portion of the nasal cavity. The method may also include instructing the medication user to inhale through the nose and exhale through the mouth or instructing the medication user to seal the mask around the nose. In another implementation, the method includes enhancing a turbulent flow pattern of the aerosolized medication prior to entering the nasal cavity of the medication user.

In still another general aspect, a nasal mask worn by a user includes a generally curved wall defining an open cavity with a continuous edge extending from a broad base to a narrow apex, a port proximate to the apex, and a seal attached to the edge. The apex is positioned proximate to a bridge of the user's nose and the port provides fluid communication with the open cavity. A vaporized substance that enters the port is available to enter the nasal cavity of the user in a turbulent flow pattern.

Implementations may include features described above or one or more of the following features. For example, the nasal mask may include a flow tube having an irregular surface connecting the port of the nasal mask to an aerosolizer device. A baffle, including a plurality of protrusions, a cylindrical member, or a flat member, may extend from an inside surface of the mask and so that it is positioned between the user's nostril and the port. The nasal mask may also have a pleasant flavor or a scent infused into a material of the wall.

### DESCRIPTION OF THE DRAWINGS

FIG. 1 shows a nasal drug delivery system.

FIGS. 2-4 show views of a nebulizer mask.

FIG. 5 shows a user wearing a nebulizer mask.

FIGS. 6A and 6B show a sinus cavity treated with a dyed medication.

### DETAILED DESCRIPTION

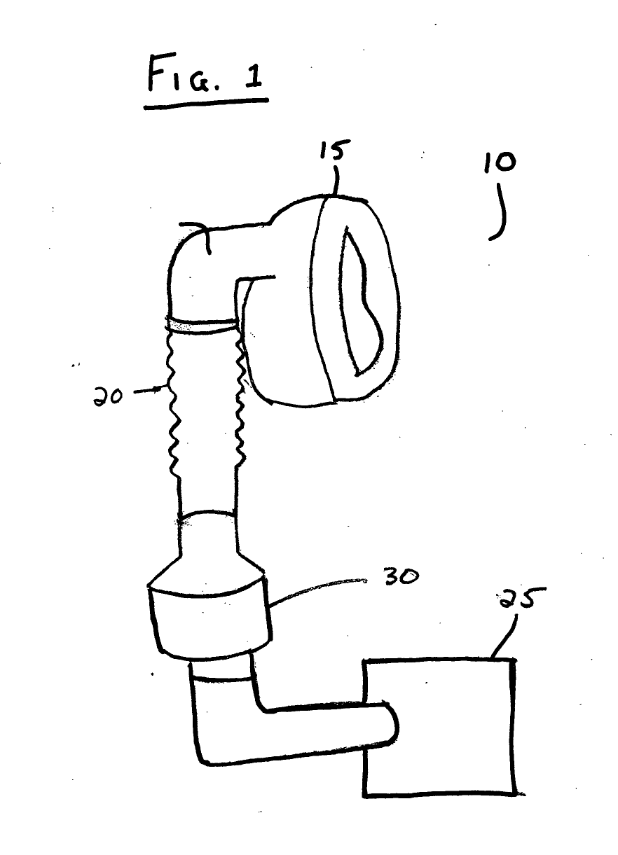

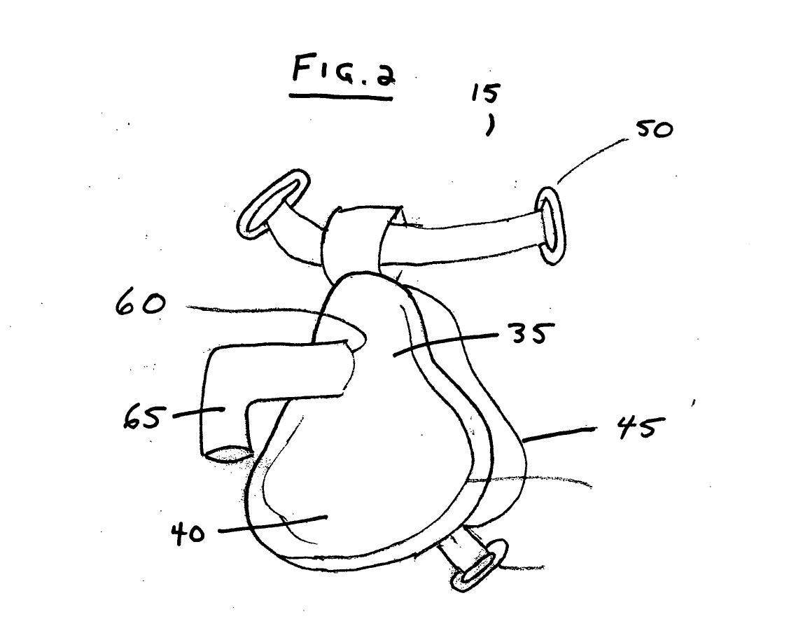

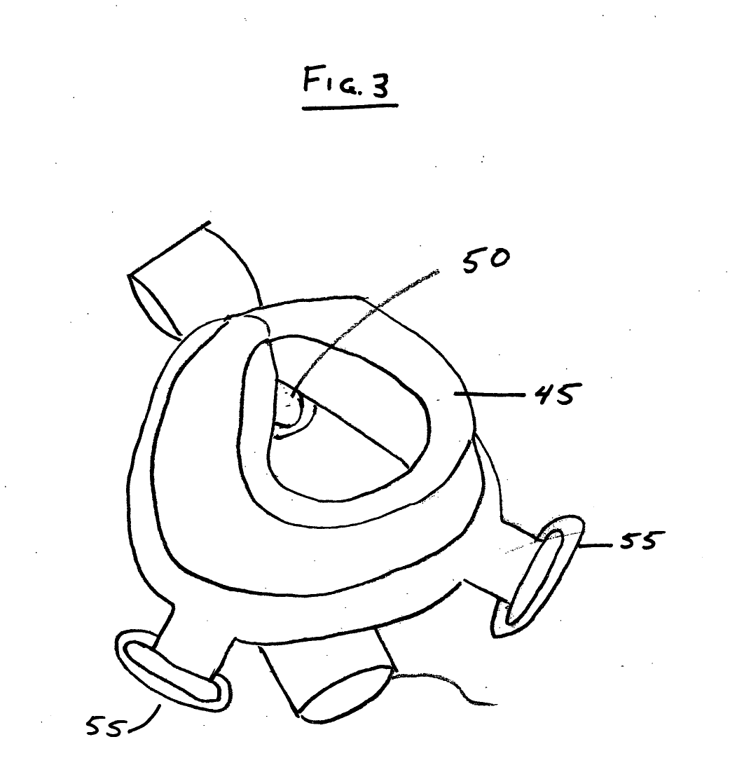

Referring to FIG. 1, the nasal drug delivery system 10 includes a mask 15, a tubing section 20, and an aerosolizer with a medication cup 30 connected to an air pressure source, such as, for example, a nebulizer 25. Referring to FIGS. 2-4, the mask 15 may be oval shaped or pyramid shaped with an upper portion 35 and a base 40. The mask 15 includes a sealing edge 45 that is configured to form a cup or chamber around a nose of a user. The seal around the nose prevents medication loss and avoids irritation of the eyes and face. Attachment straps 50, 55 are fixed to the upper portion 35 and the base 40 of the mask 15.

The mask 15 may be made in various sizes to accommodate adults and pediatric patients. The mask 15 may also be infused with a pleasant scent to make wearing the mask a more pleasant experience, particularly for pediatric patients.

A port 60 on the mask 15 is positioned in the upper portion 35 of the mask 15 proximate to the dorsal section or bridge of the user's nose. Referring again to FIG. 1, the port 60 is fluidly connected to a right-angled channel 65 with a sufficient diameter to receive a flow tube 20. The other end of the flow tube 20 is connected to a medication cup 30 and the medication cup 30 is connected to the nebulizer 25.

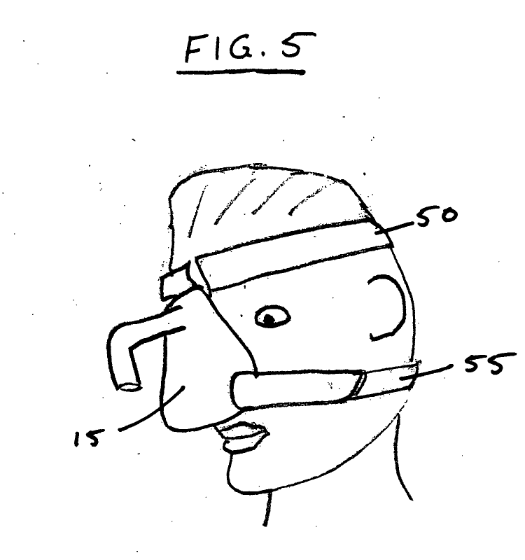

In use, the device is assembled as explained above. A method of using the nebulizer system includes adding an appropriate amount of medication to the medication cup and activating the air pressure source, such as, for example, the nebulizer apparatus. Referring to FIG. 5, the user is instructed to position the mask around the nose and to tighten the attachment straps so that the mask creates a seal around the nose. The user then is instructed to breathe by inhaling through the nose and exhaling through the mouth.

During inhalation, nebulized medication flows from the medication cup 30, through the tube 20, and into the chamber of the mask 15. The position of the port 60 prevents a straight and smooth flow of medication into the nostrils. Instead, the medication may travel in a circuitous pattern in the chamber and around the nose, accentuating the natural breathing pattern that emulates turbulent flow.

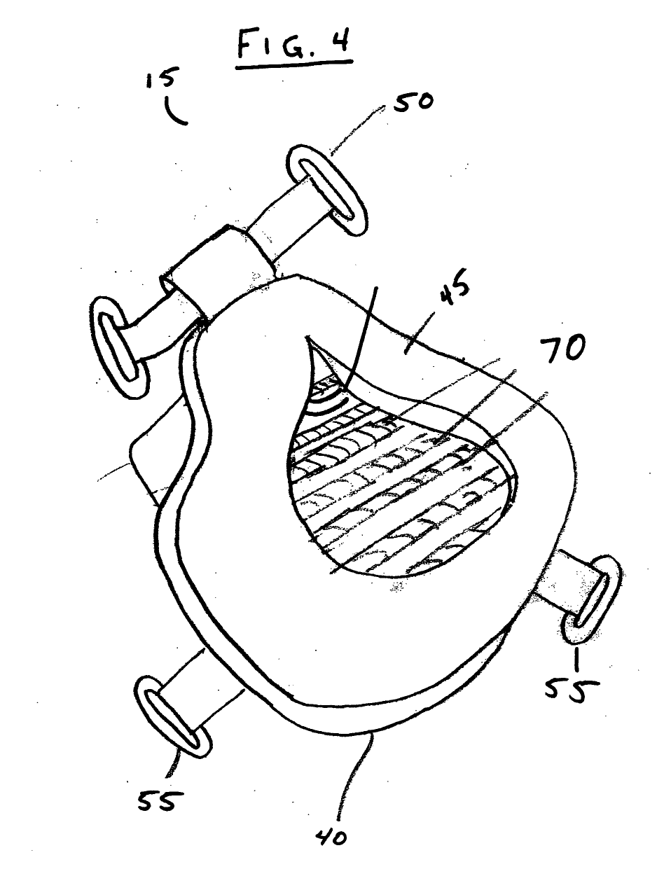

In one implementation, the tube 20 and/or the inside of the mask 15 include corrugated surfaces to further accentuate the turbulent flow pattern. In another implementation, as shown in FIG. 4 the inside surface of the mask 15 includes baffles 70 that also cause a turbulent flow pattern. The baffles can be cylindrical or flat structures extending from the inside surface of the mask.

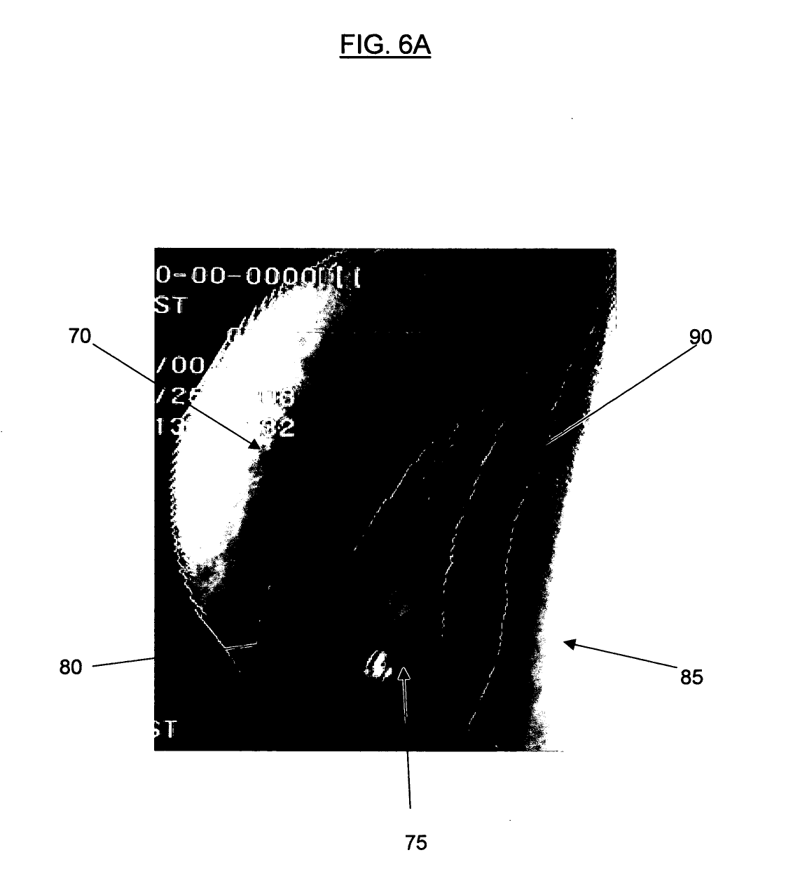

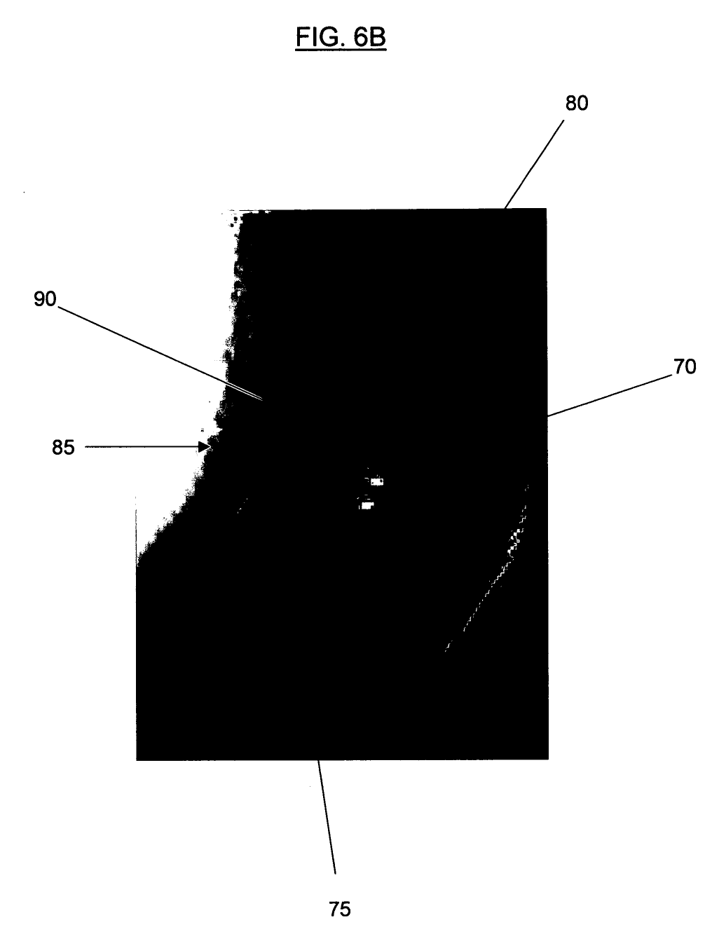

FIGS. 6A and 6B show intranasal distribution of a dyed medication after nebulization with the nasal drug delivery system 10. FIG. 6A is dye staining of the right nasal cavity and FIG. 6b is staining of the left nasal cavity of the same medication user.

The lateral intranasal wall 70, which is the lateral most boundary of the nasal cavity, exhibits staining that encroaches right up to the boundary. The middle turbinate 75, which is considered the central intranasal structure, shows staining on both sides. The superficial sinus cavity 80 also exhibits staining on both sides. The nasal septum 85, which divides the two nasal cavities and is the most medial boundary of the nasal cavity, shows staining that encroaches right up to this boundary. The deep sinus cavity 90 also shows staining on both sides. Thus, the result is the efficacious bilateral distribution of the nebulized agent with the dye distributed deep into the nasal cavity and sinuses.

While the invention has been described with reference to a particular embodiment, those skilled in the art will appreciate that modifications may be made. Therefore, the present invention is not limited to the embodiments described above, but encompasses any and all embodiments within the scope of the following claims.

1. A nasal drug delivery system delivering aerosolized medication through the nasal passages of a user, comprising:
a nasal mask that includes:
a concave wall having an upper portion widening to a base portion,
a sealing member surrounding an edge of the wall such that the wall defines a sealed chamber in fluid communication with the nasal passages of the user, and
a port providing fluid communication with the chamber, the port being positioned in the upper portion of the nasal mask; and
an aerosolizer device connected to the port of the nasal mask and being operable to deliver the aerosolized medication to the chamber;
wherein the aerosolized medication in the chamber is available to enter the nasal passages during a normal inhalational breathing pattern of the user.

2. The system of claim 1, the aerosolizer device comprises an air pressure source aerosolizing the medication via a medication cup and delivering the aerosolized medication to the chamber.

3. The system of claim 1, wherein the aerosolizer device comprises a nebulizer.

4. A method of intranasal medication delivery, comprising:
aerosolizing a medication;
delivering the medication to a chamber configured to envelope a nose of a medication user; and
causing a turbulent flow of the aerosolized medication to be made available to enter the nasal cavity of the medication user.

5. The method of claim 4, further comprising:
depositing the aerosolized medication along the lining of the nasal cavity.

6. The method of claim 5, wherein the depositing further comprises depositing the aerosolized medication to a superior portion of the nasal cavity.

7. The method of claim 4, further comprising:
instructing the medication user to inhale through the nose and exhale through the mouth.

8. The method of claim 4, further comprising:
instructing the medication user to seal the mask around the nose.

9. The method of claim 4, further comprising:
enhancing a turbulent flow pattern of the aerosolized medication prior to entering the nasal cavity of the medication user.

10. A nasal mask worn by a user, comprising:
a generally curved wall defining an open cavity with a continuous edge extending from a broad base to a narrow apex, the apex being configured to be positioned proximate to a bridge of the user's nose;
a port proximate to the apex, the port providing fluid communication with the open cavity; and
a seal attached to the edge;
wherein a vaporized substance that enters the port is available to enter the nasal cavity of the user in a turbulent flow pattern.

11. The nasal mask of claim 10, further comprising:
a flow tube having an irregular surface connecting the port of the nasal mask to an aerosolizer device.

12. The nasal mask of claim 10, further comprising:
a baffle extending from an inside surface of the mask and positioned between the user's nostril and the port.

13. The nasal mask of claim 12, wherein the baffle comprises a plurality of protrusions.

14. The nasal mask of claim 12, wherein the baffle comprises a cylindrical member.

15. The nasal mask of claim 12, wherein the baffle comprises a flat member.

16. The nasal mask of claim 10, wherein the nasal mask comprises a pleasant flavor and/or scent infused into a material of the wall.
